(19) United States
(12) Patent Application Publication
(10) Pub. No.: US 2006/0223039 A1
(43) Pub. Date: Oct. 5, 2006

(54) Peritoneal dialysis doll

(76) Inventor: Kathryn Williams, Bossier City, LA (US)

Correspondence Address: LITMAN LAW OFFICES, LTD, PO BOX 15035, CRYSTAL CITY STATION, ARLINGTON, VA, 22215, US

(21) Appl. No.: 11/369,760

(22) Filed: Mar. 8, 2006

Related U.S. Application Data
(60) Provisional application No. 60/666,159, filed on Mar. 29, 2005.

(51) Int. Cl. G09B 23/28

(52) U.S. Cl. 434/262

(57) ABSTRACT

The peritoneal dialysis doll, used for training patients or medical personnel in peritoneal dialysis exchanges, includes a torso that is hollow and holds a fluid reservoir. A peritoneal dialysis catheter is inserted within an opening in the torso, which serves as the exit site of the catheter, and is connected to the fluid reservoir. The catheter is attached to a transfer set that includes a valve connected to the transfer set to control the flow of dialysis solution into or out of the catheter. A tubing connector includes a Luer adapter and a transfer set connector for attaching the transfer set to the catheter with Luer fittings. The fluid reservoir is retained within the doll by fitting the reservoir inside the torso through a rear opening in the doll.

### CROSS-REFERENCE TO RELATED APPLICATION

This application claims the benefit of U.S. Provisional Patent Application Ser. No. 60/666,159, filed Mar. 29, 2005.

### BACKGROUND OF THE INVENTION

1. Field of the Invention

The present invention relates to medical mannequins, and particularly to a peritoneal dialysis doll for providing demonstrations and training to patients, medical personnel, and other caregivers in peritoneal dialysis procedures.

2. Description of the Related Art

Peritoneal dialysis is an often-used technique in aiding patients who have deteriorating renal function. Dialysis is used to cleanse the body's waste products, a function normally provided by the kidneys. In hemodialysis, the patient is required to periodically go to a dialysis facility where the patient is attached to a dialysis machine having a filter for removing the waste products, the procedure being performed by medical personnel. Peritoneal dialysis is a procedure that can be performed by the patient without supervision, and provides the patient with greater independence.

Peritoneal dialysis, in particular, first requires the insertion of a catheter into the peritoneum of the patient. The catheter extends out of the abdominal cavity of the patient. A specially prepared solution called a dialysis solution, or dialysate, is introduced into the peritoneal cavity. Waste products and excess water are filtered from blood flowing through the tissue of the peritoneum into the dialysate by diffusion and osmosis. The dialysate must be changed regularly in order to maximize removal of waste products and fluid from the patient's body.

There are two types of peritoneal dialysis: continuous cycling peritoneal dialysis and continuous ambulatory peritoneal dialysis. In continuous cycling peritoneal dialysis, the patient connects the catheter to a machine called a cycler, which automatically changes the bags of dialysis solution at proper time intervals while the patient sleeps. In continuous ambulatory peritoneal dialysis, the dialysis solution is introduced into the peritoneal cavity by gravity and cleanses the waste products from the blood while the patient goes about his or her normal activities. However, the dialysis solution must be drained and replaced at intervals throughout the day, e.g., every four to six hours.

One of the more frequently encountered problems with peritoneal dialysis is that infection may occur, either around the exit site of the catheter or in the peritoneal cavity itself. It is therefore important that patients be properly instructed in procedures for performing peritoneal dialysis, and for inspecting and cleansing the area around the catheter exit site. It is also important that medical personnel be trained in such procedures, both so that they can properly perform the procedure themselves and so that they can properly instruct patients or the patient's relatives or caregivers in the procedure.

A problem with providing such instruction and training is that it is often difficult to do so adequately solely through verbal or written instruction. While photographs and diagrams offer some assistance in communicating instructions, nevertheless such instructional material is often cumbersome or incomplete. It is of critical importance that patients, medical workers, nurses and others involved in the dialysis process be properly trained in dialysis technique. According to the United States Renal Data Services (USRDS), the projected number of dialysis patients in the year 2010 will be approximately 700,000, and each of those patients will have to rely on the training their medical caregivers have received.

Nosocomial infections are quite common in dialysis patients and can be fatal if left untreated. These nosocomial infections arise due to the lack of proper training of both the patient and in the patient's medical caregivers. A device, allowing a medical caregiver in training to simulate the dialysis procedures, is a necessary training tool and will aid in preventing medical problems, such as nosocomial infections, which can be fatal to the patient.

While numerous dolls or physical models exist within the medical community for training hospital staff and others for various purposes, such dolls or models are not particularly suited to simulate peritoneal dialysis techniques. Accordingly, there is a need for a doll that may actually simulate peritoneal dialysis for training purposes. Thus, a peritoneal dialysis doll solving the aforementioned problems is desired.

### SUMMARY OF THE INVENTION

The peritoneal dialysis doll is a doll used for training patients, medical personnel, and other caregivers in peritoneal dialysis procedures. Dialysis may be physically performed on the doll so that the appropriate procedure involved in dialysis may be accurately represented during training. The doll is generally in the shape of human body, either adult or child, and has at least a torso, but may additionally include a head, arms or legs.

The torso of the doll is hollow and houses a fluid reservoir, the torso being surrounded by a fabric covering so that the body of the doll retains a soft feel. A peritoneal dialysis catheter is a tube inserted within an opening in the torso, which serves as the exit site of the catheter. The catheter is connected to the fluid reservoir. The catheter may have a Luer adapter attached thereto so that a transfer set can be attached to the catheter. The transfer set includes a valve connected to the transfer set so that a bag of dialysis solution can be connected to the valve by appropriate tubing, and the flow of dialysis solution into the fluid reservoir is controlled by the valve.

In performing peritoneal dialysis on the doll, dialysis solution flows through the transfer set and the catheter into the fluid reservoir located within the hollow torso. The solution can be drained from the fluid reservoir with the doll in either a sitting or supine position.

The fluid reservoir is retained within the doll by fitting the reservoir inside the torso through a rear opening in the doll. The rear opening may be covered by a resilient plastic flap, or may have a reclosable fastener, such as a zipper or by interlocking hook and loop fastening material.

These and other features of the present invention will become readily apparent upon further review of the following specification and drawings.

### BRIEF DESCRIPTION OF THE DRAWINGS

FIG. 1 is a front perspective view of a peritoneal dialysis doll according to the present invention.

FIG. 2 is a detailed, perspective view of the peritoneal dialysis doll according to the present invention.

FIG. 3 is a perspective view of the peritoneal dialysis doll according to the present invention with the transfer set exploded from the catheter.

FIG. 4 is a rear perspective view of the peritoneal dialysis doll according to the present invention.

FIG. 5 is a rear perspective view of the peritoneal dialysis doll according to the present invention, but showing an additional embodiment.

Similar reference characters denote corresponding features consistently throughout the attached drawings.

### DETAILED DESCRIPTION OF THE PREFERRED EMBODIMENT

The present invention is a peritoneal dialysis doll to be used by patients or medical personnel to familiarize themselves with methods of performing peritoneal dialysis exchanges. The peritoneal dialysis doll, designated generally as 10 in the drawings, allows users to perform dialysis on the doll itself so that the users are able to understand the correct procedure for setting up exchanges of dialysis solution. The doll 10 resembles an infant in the Figures, however, it should be understood that doll 10 may be sized and shaped to resemble a human patient of any size, age, gender or race, depending upon the needs and desires of the user.

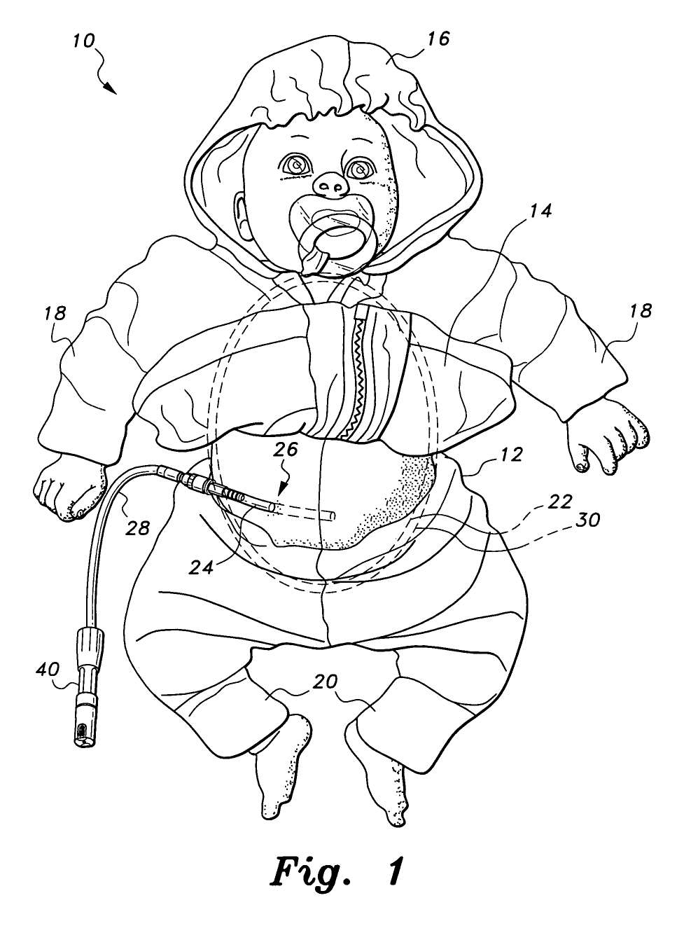

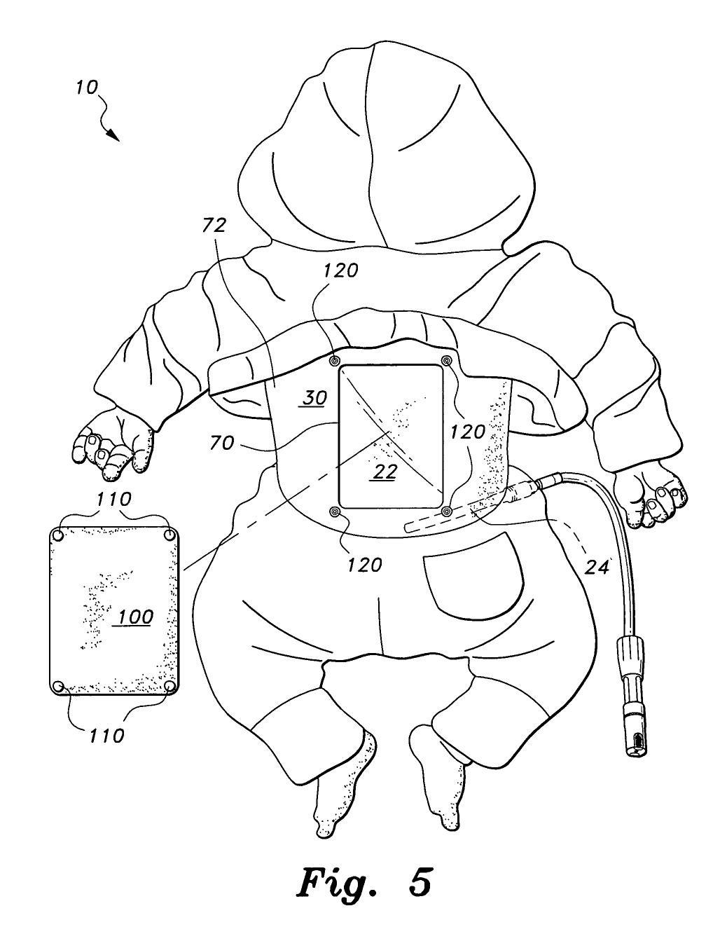

Referring first to FIG. 1, the peritoneal dialysis doll 10 is a training model that simulates a life-size human patient, providing dialysis trainees with a simulation of a human patient for purposes of practicing dialysis technique. The doll 10 includes a body portion 12 having at least a torso 14, but may additionally include a head 16, arms 18 and legs 20 attached to the torso 14 in conventional fashion in order to replicate a typical body. The torso 14 is hollow and is able to hold a fluid reservoir 22 that is disposed within the hollow torso 14. The fluid reservoir 22 may be a water-impermeable plastic bag or bladder. A fabric covering 30, e.g., a layer of cotton, may surround the fluid reservoir 22 in order to provide the body portion 12 of the doll 10 with a softer, more realistic feel. Alternatively, with specific reference to the embodiment shown in FIG. 5, the reservoir may be uncovered and placed directly within the hollow torso portion, to be described below, and covered only by the exterior covering of the doll. The exterior covering simulates human skin and is formed from a material such as rubber, or any other suitable material commonly used in the manufacture of dolls.

Though fluid reservoir 22 may be sized and shaped dependent upon the needs of the user, and dependent upon whether doll 10 simulates an adult or child, in the preferred embodiment, fluid reservoir 22 is a plastic bladder with an interior volume of approximately 2.5 L. Fluid reservoir 22 is preferably at least partially transparent, allowing the user to monitor the fluid level within reservoir 22 (with reference to the embodiment of FIG. 5), for training purposes.

A peritoneal dialysis catheter 24 is connected to the fluid reservoir 22 housed within the hollow torso 14. The catheter 24 is made from flexible tubing and extends out of a catheter exit site 26 in the torso 14 of the doll 10, the exit site 26 being located lateral to the navel and above the groin, simulating the catheter placement in a human patient. A transfer set 28 is connected to the catheter 24 via a tubing connector. A valve 40 is attached to the transfer set 28 and is adapted for connection to a supply of dialysis solution, or simulated dialysis solution. The valve 40 may be opened or closed to permit or preclude the dialysis solution to flow into or out of the peritoneal cavity. Dialysis solution may therefore flow into fluid reservoir 22 when first performing peritoneal dialysis or out of the fluid reservoir 22 when peritoneal dialysis is being completed.

In performing peritoneal dialysis on the doll 10, when the valve 40 is open, dialysis solution flows through the transfer set 28 into the catheter 24 into the fluid reservoir 22 located within the hollow torso 14. The solution may thereafter be drained from the fluid reservoir 22 with the doll 10 in a sitting or supine position.

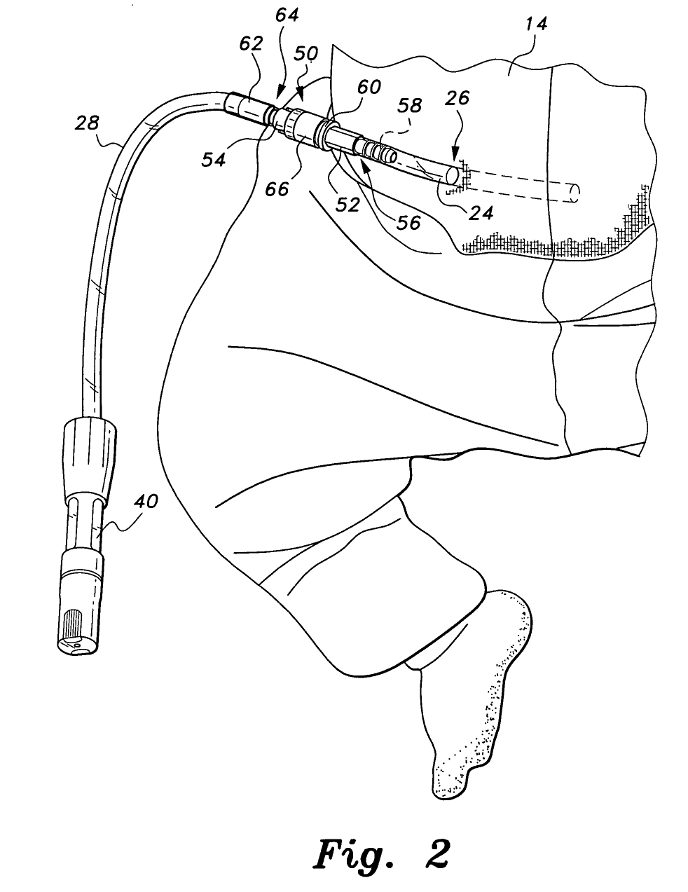

FIG. 2 shows a more detailed view of the catheter 24 and transfer set 28. The catheter 24 extends from within the hollow torso 14 out of the doll 10 through the catheter exit site 26. The catheter 24 generally extends at least two inches from the exit site 26 and may extend four inches or more from the exit site 26, depending on the size of the doll and the procedure to be demonstrated.

A tubing connector 50 attaches the catheter 24 to the transfer set 28. The tubing connector 50 includes a Luer adapter 52 and a transfer set connector 54. The Luer adapter 52 has a ribbed end 58 inserted within the open end 56 of the catheter 24 and an end 60 with a Luer lock fitting. One such exemplary Luer lock fitting is the Luer-Lok, manufactured by BD Vacutainer®. The transfer set connector 54 has a ribbed end 62 inserted within the open end 64 of the transfer set 28 and an end 66 with a mating Luer-Lok fitting.

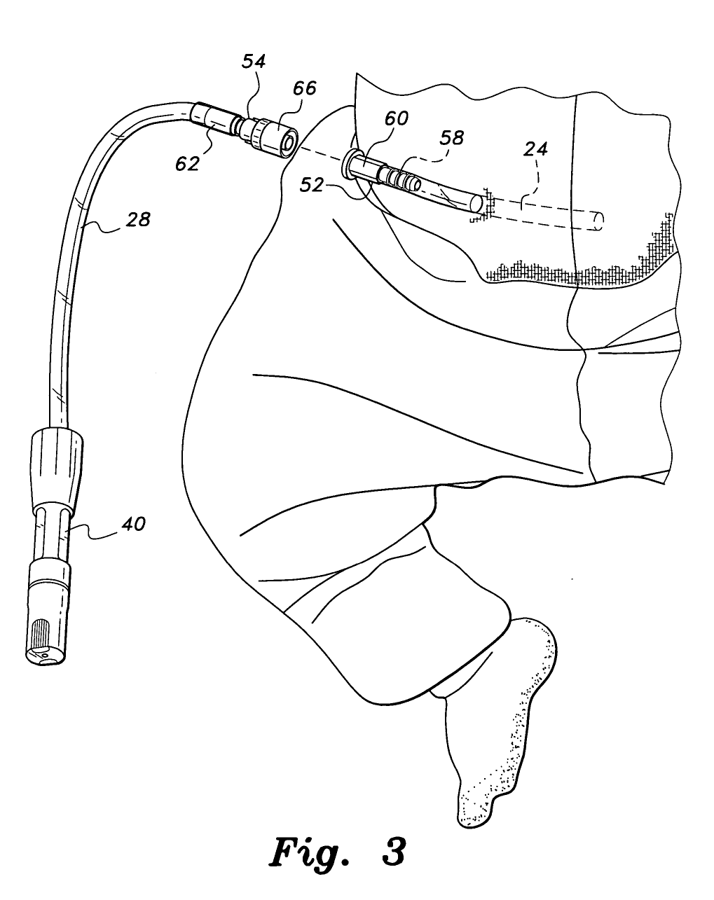

FIG. 3 shows a detailed perspective view of the catheter 24 detached from the transfer set 28. The Luer end 66 of the transfer set connector 54 is adapted to lock into the Luer 60 of the adapter 52. Either a male or female Luer fitting ends 60 and 66, providing the Luer ends 60 and 66 are able to mate, thereby attaching the catheter connector 52 to the transfer set connector 54. The transfer set 28 is attached to the valve 40, which controls fluid flow into or out of the catheter 24.

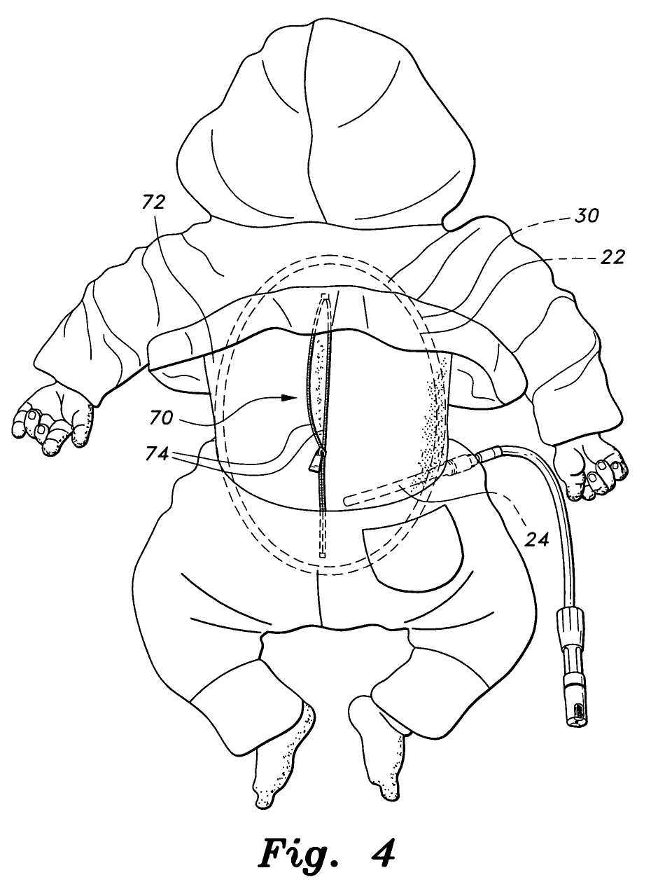

Turning now to FIG. 4, a rear view of the peritoneal dialysis doll 10 is shown. The doll 10 includes a rear opening 70 defined within a back portion 72 of the torso 14. The rear opening 70 allows the fluid reservoir 22 to be placed within the peritoneal dialysis doll 10 and then removed and refilled with fluid if necessary to illustrate peritoneal dialysis. The fluid reservoir 22 is replaced inside the hollow torso 14 of the doll 10 through the rear opening 70.

The rear opening 70 may be closed by a resilient plastic flap, or by a reclosable fastener, such as interlocking zipper portions 74, holding the rear opening 70 closed so that the fluid reservoir 22 remains within the doll 10. Additionally, in place of the zipper portions 74, interlocking hook and loop strips may be placed on either side of the rear opening 70 and overlapped such that the rear opening 70 stays closed, holding the fluid reservoir 22 inside the peritoneal dialysis doll 10.

In the alternative embodiment of FIG. 5, the zipper closure 74 is replaced with a removable flap 100. Opening 70 formed through the back portion of the torso is shown as having a substantially rectangular contour, however, it should be understood that opening 70 may have any suitable size or contour, dependent upon the needs and desires of the user. Opening 70 provides access to reservoir 22, allowing the user to either remove or replace reservoir 22, or to monitor the fluid level within the reservoir. It should be noted that in this embodiment, reservoir 22 is not covered by fabric covering 30, allowing users to visually inspect the fluid level within fluid reservoir 22.

First fixture elements 120 are mounted on the rear portion of doll 10 about the periphery of opening 70, as shown. First fixture elements 120 releasably engage a set of second fixture elements 110 mounted on removable flap 100. First and second fixture elements 120, 110 may be snap-type fasteners as shown, or may be any suitable releasable fasteners, such as hook and loop type fasteners, for example. Flap 100 is preferably formed from the same material as the remainder of the torso, thus simulating a patient's back when flap 100 is secured to the remainder of doll 10.

It is to be understood that the present invention is not limited to the embodiments described above, but encompasses any and all embodiments within the scope of the following claims.

I claim:

1. A peritoneal dialysis doll, comprising:
a body portion having at least a hollow torso having an opening therein defining a catheter exit site;
a fluid reservoir disposed within the torso; and
a peritoneal dialysis catheter connected to the fluid reservoir and extending through the catheter exit site;
whereby fluid flows into and out of the fluid reservoir through the peritoneal dialysis catheter.

2. The peritoneal dialysis doll according to claim 1, further comprising a transfer set connected to the peritoneal dialysis catheter.

3. The peritoneal dialysis doll according to claim 2, further comprising a valve connected to the transfer set, the valve being adapted for connection to a supply of dialysis fluid.

4. The peritoneal dialysis doll according to claim 2, further comprising an adaptor for interconnection of said transfer set and said peritoneal dialysis catheter.

5. The peritoneal dialysis doll according to claim 4, wherein said adaptor includes a catheter connector portion having a Luer lock end for connection to said peritoneal dialysis catheter.

6. The peritoneal dialysis doll according to claim 5, wherein said adaptor further includes a transfer set connector having a Luer lock end for connection to said transfer set.

7. The peritoneal dialysis doll according to claim 1, wherein a back portion of said hollow torso has an access opening formed therethrough for providing access to said fluid reservoir.

8. The peritoneal dialysis doll according to claim 7, further comprising a releasable closure for selectively and releasably sealing said access opening.

9. The peritoneal dialysis doll according to claim 7, further comprising a releasable flap for selectively and releasably covering said access opening.

10. The peritoneal dialysis doll according to claim 9, further comprising at least one releasable fixture element mounted on said back portion adjacent a periphery of said access opening, said at least one releasable fixture element releasably engaging said releasable flap.

11. The peritoneal dialysis doll according to claim 1, further comprising a fabric cover for covering said fluid reservoir.
